(19) United States
(12) Patent Application Publication
(10) Pub. No.: US 2024/0374083 A1
(43) Pub. Date: Nov. 14, 2024

(54) COOKING APPARATUS WITH AIR FLOW REVERSAL

(71) Applicant: Jean DESPRÉS, St-Antonin (CA)

(72) Inventor: Jean DESPRÉS, St-Antonin (CA)

(21) Appl. No.: 18/696,723

(22) PCT Filed: Oct. 3, 2022
(86) PCT No.: PCT/CA2022/051465

§ 371 Date: Mar. 28, 2024

Related U.S. Application Data
(60) Provisional application No. 63/251,198, filed on Oct. 1, 2021.

(51) Int. Cl. A47J 37/07

(52) U.S. Cl. CPC A47J 37/0754; A47J 37/0704

(57) ABSTRACT

A cooking apparatus may have a vat configured to accommodate a heat source, the vat having a top open end. A grate covers the top open end and configured to receive foodstuff thereon to expose the foodstuff to heat from the heat source. A ventilation conduit extends from a bottom and/or a side of vat, the ventilation conduit having a first end in fluid communication with the vat, and having a second end away from the vat. The second end of the ventilation conduit is alternatively an air intake and a smoke exhaust.

### CROSS-REFERENCE TO RELATED APPLICATION

The present application claims the priority of U.S. Patent Application No. 63/251,198, filed on Oct. 1, 2021 and incorporated herein by reference.

### TECHNICAL FIELD

The present application relates to cooking apparatuses cooking on an open flame, live fire, also known as barbecues (i.e., BBQ, barbeque), grills, etc, and to cooking techniques known as barbecuing, grilling, broiling.

### BACKGROUND

Barbecues, grills and like cooking apparatuses are a staple for cooking foodstuff. The exposure of the foodstuff to an open flame/live fire results in the foodstuff, such as meats, vegetables, fish, having a unique flavor, notably because of the smoke and the contact with a grill grate. Such cooking apparatuses typically have a vat enclosing a live fire heat source, such as charcoal briquettes, wood pieces or pellets, or gas tubes located below a grill grate. Heat retaining members, like rocks, may also be present in the vat. The foodstuff is deposited on the grill grate so as to be exposed to the heat from the live fire in vat thereunder.

It is known that oils are commonly present in foodstuff, by naturally being present in meats and vegetables, and may be added to the grill in such open flame cooking. Likewise, foodstuff may be marinated and many naturally have liquid content. Therefore, such oils and liquids may tend to drip onto the open flame. There results smoke and/or excessive flames that may burn the foodstuff. Excessive smoke may be unhealthy or toxic and may spoil the taste of the foodstuff. Moreover, as the grill(s) is (are) located above the flame source, air passages enabling oxygen to feed the live flame may be limited, affecting the efficiency of the combustion. A lack of efficiency in the combustion may result in one or more of lower temperature, slower cooking time, inadequate cooking temperature for some types of cooking, and more smoke.

### SUMMARY

It is an aim of the present disclosure to provide a cooking apparatus that addresses issues related to the prior art.

In one aspect, there is provided a cooking apparatus comprising a vat configured to accommodate a heat source, the vat having a top open end; a grate covering the top open end and configured to receive foodstuff thereon to expose the foodstuff to heat from the heat source; and a ventilation conduit extending from a bottom and/or a side of vat, the ventilation conduit having a first end in fluid communication with the vat, and having a second end away from the vat; wherein the second end of the ventilation conduit is alternatively an air intake and a smoke exhaust.

Further in accordance with the first aspect, for instance, the vat tapers downwardly, the vat having an inverted truncated square pyramid shape.

Still further in accordance with the first aspect, for instance, the vat is made of a refractory cement.

Still further in accordance with the first aspect, for instance, the vat has ribs on its inner surface, the ribs defining air channels between the top open end and a bottom of the vat.

Still further in accordance with the first aspect, for instance, the vat and the ventilation conduit are in fluid communication via an opening at a bottom of the vat.

Still further in accordance with the first aspect, for instance, the second end of the ventilation conduit is an end of a chimney.

Still further in accordance with the first aspect, for instance, a trap is provided in the chimney to adjust a size of an air passage of the chimney.

Still further in accordance with the first aspect, for instance, the trap is pivotably mounted to a wall of the chimney.

Still further in accordance with the first aspect, for instance, a ventilator is connected to the chimney.

Still further in accordance with the first aspect, for instance, the chimney has a portion thereof removable from a remainder of the ventilation conduit.

Still further in accordance with the first aspect, for instance, closeable vents are provided in the ventilation conduit to enable air passage between the first end and the second end.

Still further in accordance with the first aspect, for instance, a removable hood portion is configured to be mounted around the vat.

Still further in accordance with the first aspect, for instance, a horizontal plane and a vertical plane pass through the cooking apparatus to form four quadrants, the grate being in a first quadrant, the vat being in a second quadrant, and the ventilation conduit being in the second quandrant, a third quadrant and a fourth quadrant.

In accordance with another aspect, there is provided a method of operating a cooking apparatus comprising: causing a combustion in a vat of the cooking apparatus; exposing foodstuff to heat from the combustion on a grate mounted atop the vat; and inducing an air flow from an environment of the grate, through the vat, and to an exhaust of a ventilation conduit.

### DESCRIPTION OF THE DRAWINGS

Reference is now made to the accompanying figures in which:

FIG. 1 is a perspective view of a cooking apparatus with air flow reversal in accordance with a first aspect of the present disclosure;

FIG. 2 is a cross-sectional view of the cooking apparatus of FIG. 1;

FIG. 3 is a perspective view of a cooking apparatus with air flow reversal in accordance with a second aspect of the present disclosure;

FIG. 4 is a cross-sectional view of the cooking apparatus of FIG. 3;

FIG. 5 is a perspective view of the cooking apparatus of FIG. 1, in a double vat set-up;

FIG. 6A is a perspective view of the cooking apparatus of FIG. 5, with a cooking hood in a stowed positon;

FIG. 6B is a perspective view of the cooking apparatus of FIG. 5, with a cooking hood in a covering positon;

FIG. 7 is a perspective view of the cooking apparatus of FIG. 5, with an oven assembly;

FIG. 8 is a perspective view of the oven assembly of FIG. 7;

FIG. 9 is a perspective sectional view of the oven assembly of FIG. 7; and

FIG. 10 is a longitudinal sectional view of the oven assembly of FIG. 7.

### DETAILED DESCRIPTION

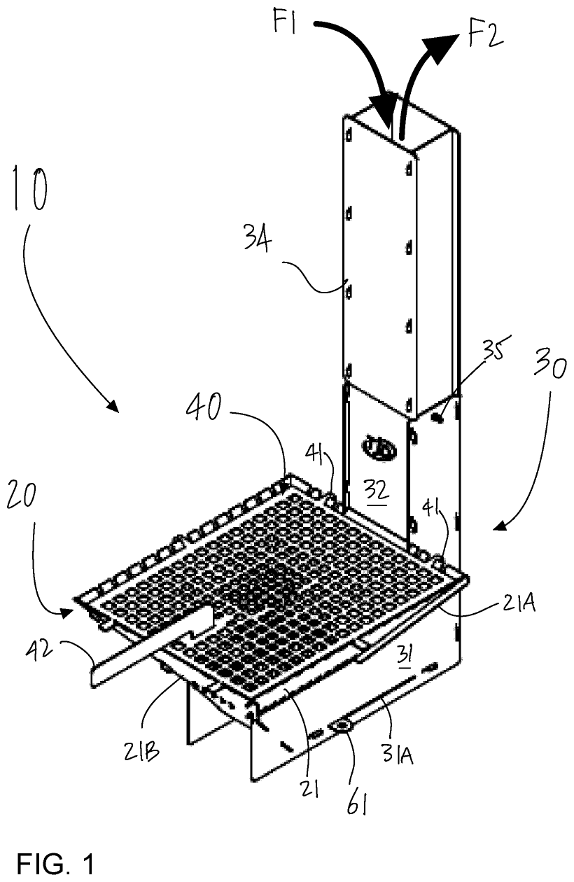

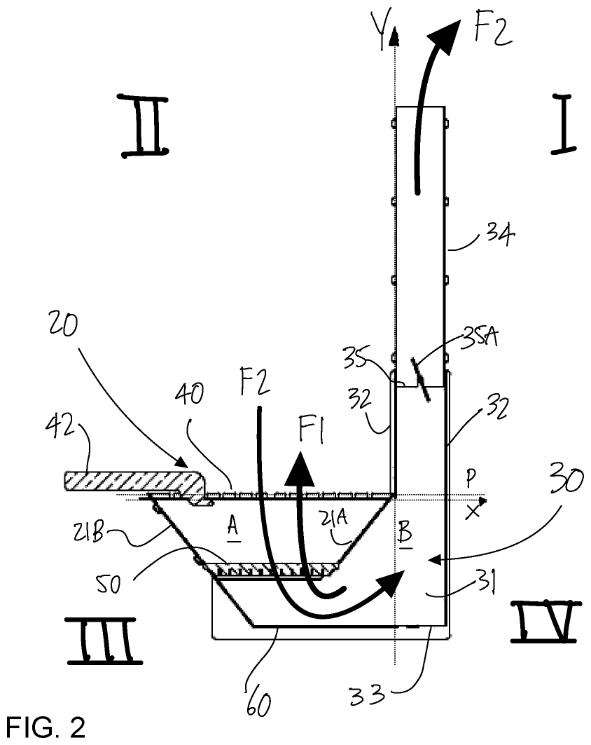

Referring to FIGS. 1 and 2, a cooking apparatus with air flow reversal in accordance with the present disclosure is generally shown as 10. For simplicity, reference is made herein to cooking apparatus 10. The cooking apparatus 10 may also been known as a barbecue, BBQ, barbeque, as a grill, as an outdoor cooker, an live fire cooker, and open flame cooker, among other names and is of the type that is used to expose foodstuff to an open flame, to a live fire. In a variant, the cooking apparatus 10 is said to be portable, in that it may be transported manually, by a single adult of regular strength.

The cooking apparatus 10 has a vat 20, a ventilation conduit 30, a grill grate 40, a soild fuel tray 50, and/or an ash trap 60 that may alternatively or additionally be used as a drip tray. In an embodiment, a fan 70 may be present. Some of these components may be absent and other components may also be present. For example, some of the components described above may be sold separately from a remainder of the cooking apparatus 10. Exemplary quadrants are shown in some of the figures, as depicted by a horizontal axis X and a vertical axis Y in FIG. 2, that are essentially a horizontal plane and a vertical plane, relative to the shown orientation, i.e., the orientation of the cooking apparatus 10 when used. The quadrants are shown as I (+x, +y), II (−x, +y), III (−x, −y) and IV (+x, −y), and are provided to illustrate a possible but not exhaustive arrangement of the components of the cooking apparatus 10. In a variant, the horizontal plane X is below the grill grate 40, with the grill grate 40 and foodstuff thereon being in quadrant Il.

The vat 20 is the part of the cooking apparatus 10 where heat is generated, in the form of an open flame. In FIG. 2, the vat 20 is the quadrant III. The vat 20 may also be devised to accommodate briquettes, lump charcoal, rocks, wood, or other solid fuels/combustible solids, or other types of heat sources such as gas tubes or electric coils. For such other types of heat sources, shielding plates, may be present, for example. The vat 20 may be known as a receptacle, as a body, as a bin, as a pit or fire pit, among other names.

The vat 20 defines an inner cavity A that receives solid fuel or other heat sources and/or heat retaining means (e.g., lava rocks), and has an open top to support the grill grate 40. In an aspect, the vat 20 may be defined by side walls 21. In the illustrated embodiment, the vat 20 has an inverted and truncated square pyramidal shape and therefore tapers downwardly, with the side walls 21 being interconnected into thus shape. Other shapes are considered as well. In the illustrated shape, the vat 20 may be made of flat metal plates arranged in a particular manner by being welded and/or mechanically connected together, but the vat 20 may also be cast or fabricated using other techniques. If the vat 20 is cast or fabricated according to other techniques, it may have a single side wall 21. For example, the vat 20 may have a body of ceramic or refractory cement that is mounted to the ventilation conduit 30, in fluid communication.

According to the illustrated embodiment, the side walls 21 may include a side wall 21A that is a party wall with the ventilation conduit 30, though this is an option. The side wall 21B may also extend downwardly to define a portion of the ventilation conduit 30 as described below. In a variant, the party wall may have a surface lying in the vertical plane Y. Therefore, the vat 20 defines the receptacle in which heat is generated, for example. A top edge of the vat 20 delimit a top open end of the vat 20, and may be the combination of the top edges of the side walls 21. The top edge may have slot(s) 22 or other features at various locations so as to assist in retaining the grill grate 40 in register with the top open end of the vat 20. The slots 22 are optional and other support features may be present for the grill grate 40.

The solid fuel tray 50 is optionally present at the bottom of the vat 20 and is configured to retain solid fuels in the inner cavity A of the vat 20, while allowing air circulation therethrough in a manner described below. The solid fuel tray 50 may delimit a bottom of the vat 20, if present. The solid fuel tray 50 may also be in quadrant III.

The ventilation conduit 30 defines a ventilation passage that feeds air to the vat 20, from under the vat 20, or to a side of the vat 20, at least partially under the heat source. Therefore, the vat 20 and the ventilation conduit 30 are in fluid communication, with the inner cavity B of the ventilation conduit 30 opening into the inner cavity A of the vat 20. The ventilation conduit 30 may further include a chimney portion located higher than a top cooking plane P of the vat 20. The chimney portion may constitute an air intake when the ventilation conduit 30 feeds air to the vat 20, or an exhaust for smoke when the ventilation conduit 30 exhaust smoke from the vat 20, via the bottom of the vat 20, in air flow reversal. The ventilation conduit 30 may therefore extend from quadrant III, to quadrant IV, and have the chimney portion extend upwardly into quadrant I, as an option among others.

In an aspect, the walls of the ventilation conduit 30 may support the vat 20 and thus, the ventilation conduit 30 may form of the structure of the cooking apparatus 10 that supports the vat 20 in the manner shown in FIGS. 1 and 2, with the cooking plane P being horizontal. As an alternative, the vat 20 may be supported in other ways, such as via legs projecting downwardly from the vat 20.

As shown in FIG. 2, in accordance with a non-limitative aspect, the ventilation conduit 30 has an L-shape that may be defined by a pair of L-shaped plates 31. The use of plates described herein is one contemplated construction with welding or mechanical connections, but other constructions are contemplated, such as casting. Moreover, other shapes are contemplated, such as a J shape, an obtuse angle shape, etc. The vat 20 is located on the top edges of the horizontal portion of the L-shaped plates 31 with the side wall 21A of the vat 20 being the party wall. As shown in FIG. 1, a slot 31A may be present in one or both of the L-shaped plate 31 for translating the ash trap 60 to open up or close a bottom of the ventilation conduit 30. Rectangular plates 32 are located between the L-shaped plates 31 so as to define the chimney portion of the ventilation conduit 30. Accordingly, as observed, the chimney portion of the ventilation conduit 30 has a rectangular or square cross-section but other shapes are contemplated as well. For example, it is considered to mount a cylindrical tube atop a portion of a remainder of the ventilation conduit 30 to define the chimney. A bottom plate 33 is located between the L-shaped plates 31 and defines a bottom of the ventilation conduit 30. Therefore, the inner cavity B of the ventilation conduit 30 has a generally L-shape with a horizontal section being located under the vat 20 and being in fluid communication therethrough via the solid fuel tray 50 for air to flow from the ventilation conduit 30 to the vat 20 or vice versa.

Still referring to FIGS. 1 and 2, a chimney extension 34 may be mounted atop the L-shaped plates 31 and may be removable. In an embodiment, there is no such chimney extension 34 as the L-shaped plates 31 and rectangular plates 32 provide sufficient height to define the chimney portion of the ventilation conduit 30. The removal of the chimney extension 34 may facilitate transportation, for example. A vent 35, operable via a handle 35A, may be located at a junction between the bottom portion of the chimney and the chimney extension 34, though it may be at other locations. For example, the vent 35 may be part of the chimney extension 34, if present. The vent 35 may include a flap that may be rotated to adjust a flow through the chimney in the ventilation conduit 30. Therefore, the vent 35 may act as a damper to control airflow therethrough. Other configurations may be used as well, and the vent 35 may be optional.

The grill grate 40 is seated, supported, hung atop the vat 20. For example, the grill grate 40 may be made of metal wires arranged in a grill pattern, or of a cast metal having appropriate ventilation holes and/or slots. Tabs 41 may project from an end and/or a side(s) of the grill grate 40 to be received in the slots 22 at the top edge of the vat 20, or at other locations. This ensures that the grill grate 40 is prevented from accidentally translating in the cooking plane P of the cooking apparatus 10. Hinged portions or other members may also be used though to allow movements between the grill grate 40 and the vat 20. It is also contemplated to simply sit the grill grate 40 onto the top edge of the vat 20. A handle 42 may be present for a user to manipulate the grill grate 40, if desired. The handle 42 may be integral with the grill grate 40 or may be a separable component.

The solid fuel tray 50 is also a grill-type or grid-type component having slots and/or holes therein to allow air passages. The solid fuel tray 50 is configured to support briquettes, charcoal, wood pieces, lava rocks, etc. The solid fuel tray 50 may be integral with the vat 20 or may be removable for cleaning. The solid fuel tray 50 allows airflow therethrough to allow fluid flow between the inner cavities A and B. Depending on the nature of the heat source, there may be no solid fuel tray 50. For example, when the cooking apparatus 10 is with gas tubes or electric coils, the solid fuel tray 50 may not be present.

The trap 60 may optionally be present and may be in the form of a flat plate that may be displacable in translation, for example via tab 61 projecting out of the slot 31A, to remove ashes that may accumulate at the bottom of the ventilation conduit 30, if solid fuels are used. The trap 60 may also be known or used as a drip trap to collect oils and like cooking juices. The trap 60 may be mounted to the ventilation conduit 30 in a generally air tight manner for air to move between the vat 20 and the top of the chimney.

Now that the cooking apparatus 10 has been described, a use thereof will be set forth. In an embodiment, the vat 20 is used to receive a solid fuel, such as charcoal briquettes that are set on fire. During this phase, the ventilation conduit 30 allows air to enter via its chimney portion such that the air is fed from under the vat 20 via the passage between the cavities A and B, as shown by F1. The air flow direction F1 is used when the solid fuel burns to an appropriate state, such as to form an ember bed. The air flow direction F1 is similar to a Dakota fire pit configuration, and may accelerate the burning of the solid fuel, by enhanced exposure to air. In an embodiment, when it is desired to cook foodstuff on the cooking apparatus 10, the grill grate 40 is installed in the manner shown in FIG. 1. At that point, air flow reversal may or may not be induced. The air flow reversal may have occurred initially when lighting up the solid fuel, or may occur later on during the cooking. For example, it may be desired to expose the foodtuff to the smoke via air flow F1 to flavour the foodstuff.

One contemplated manner to achieve the air flow reversal is to open up the vent 35 of the chimney portion of the ventilation conduit 30. The opening of the flap of the vent 35 may induce a flow reversal as heat may be drawn to the chimney portion due to the lack of flow constraint. Another contemplated manner to achieve the air flow reversal is to cause combustion in the chimney portion of the ventilation conduit 30. For example, a match is lit up and dropped in the ventilation conduit 30, or an elongated match is lit up and the flame is lowered in the ventilation conduit 30. It is also considered to drop or deposit a burning sheet or piece of cardboard in the ventilation conduit 30, or to have a fire starter as part of the ventilation conduit 30. There results a reversal of the air flow, with air entering the ventilation conduit 30 via the vat 20. Therefore, the air flow, such as shown as F2 in FIG. 2, passes through the grill grate 40, aerates the heat source in the vat 20, passes through the passage between the inner cavities A and B (e.g., through solid fuel tray 50) and enters the ventilation conduit 30 to exit via the chimney. Consequently, smoke and like cooking fumes may at least partially be exhausted via the chimney, thereby reducing the exposure of the foodstuff to smoke. Likewise, flames may follow the air flow F2, and thus may generally be kept away from the foodstuff. The foodstuff on the grill grate 40 is therefore exposed to the heat but the airflow being in the reverse direction as shown as F2 will carry smoke away, thereby limiting exposure of the foodstuff to smoke and flames.

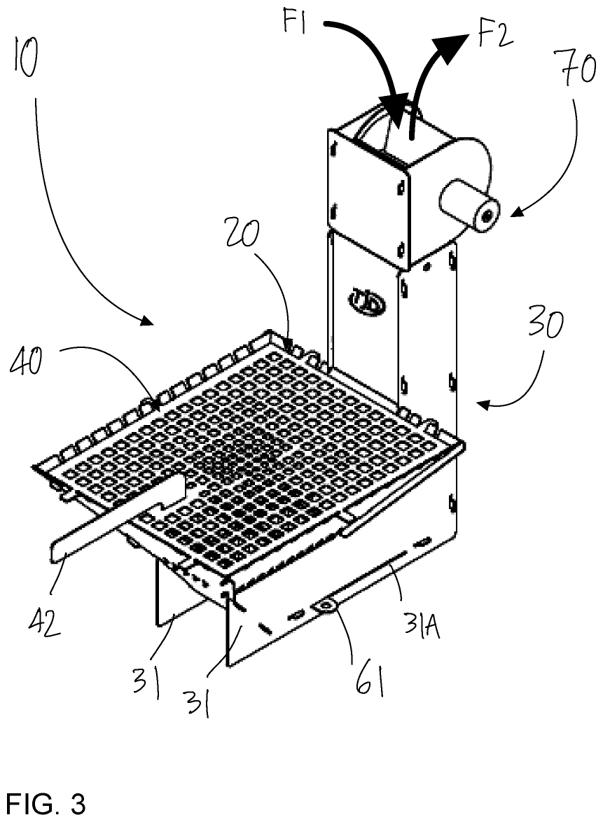

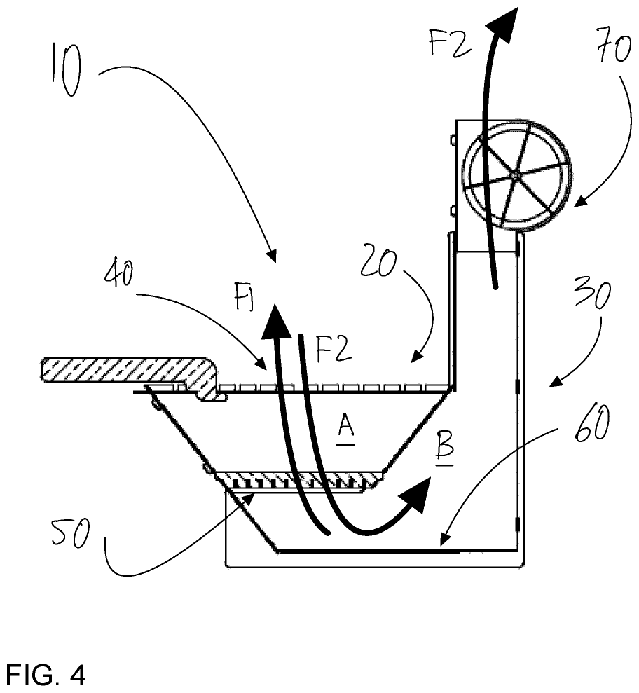

Referring now to FIGS. 3 and 4, the cooking apparatus 10 is shown in another embodiment, featuring a fan 70, or like flow inducing device. In the embodiment of FIGS. 3 and 4, reference numerals corresponding to reference numerals for the embodiment of FIGS. 1 and 2 will refer to like elements. The fan 70 may be a fan that is manually or electrically operated so as to control air flow direction. For example, a crank may be present and may be releasable detachable from the shown shaft of the fan 70. In an embodiment, a motor may be present to operate the flow reversal. The motor may be unidirectional, for example to change the air flow direction from F1 to F2. A battery may be present, with appropriate shielding to protect the motor and battery (if present) from the heat of the cooking apparatus 10. It is observed that the chimney extension 34 is absent but may also be present.

Therefore, the cooking apparatus 10 has the vat 20 featuring the cooking plane and grill grate 40 being side by side with the ventilation conduit 30 including the chimney, with the ventilation conduit 30 being in fluid communication with a bottom or a side of the vat 20. The chimney may be higher relative to the cooking plane P. Said differently, when the cooking apparatus 10 is in its proper orientation as shown in FIGS. 1 to 4, the cooking plane P is at a given height while the top end of the chimney portion of the ventilation conduit 30 is at a height greater than that of the cooking plane P. In an embodiment, there is no chimney, with the ventilation conduit 30 extending laterally away from the vat 20.

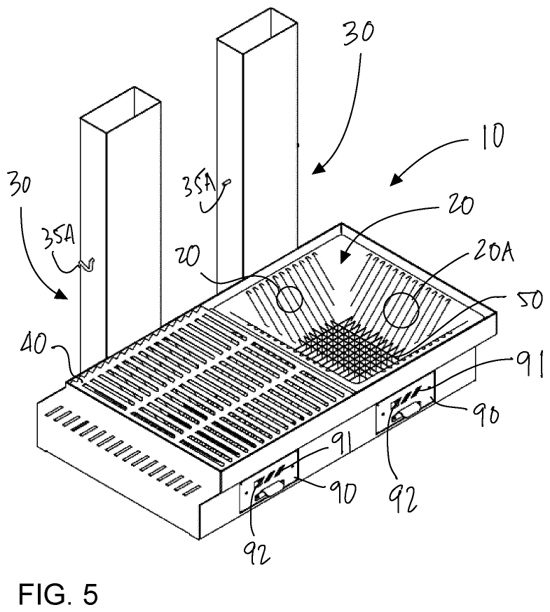

Referring to FIG. 5, another variant is shown, featuring many of the same components as in the variant of FIGS. 1 to 4. However, the cooking apparatus 10 of FIG. 5 has a pair of vats 20, each having its own ventilation conduit 30 and chimney portion. Only one grill grate 40 is shown to show the interior of one of the vats 20, implying that a second grill grate 40 is present. In a variant, a single grill grate 40 could be shared by the two vats 20.

Accordingly, the cooking apparatus 10 of FIG. 5 could be used to produce two separate open fires, each at its own temperature, for example as adjusted by air flow via the vents (shown by the handles 35A).

As other possible variants illustrated in FIG. 5, the vat 20 may be removably supported to a casing 80, the casing 80 forming the structure of the cooking apparatus 10 of FIG. 5. For example, the casing 80 could define part of the ventilation conduit 30, for instance replicating the arrangement of FIG. 2 in quadrants III, IV and I, as a possibility among others. The vat 20 of FIG. 5 may be a single piece component, support by its upper periphery (e.g., flange, lip, etc). As a possibility, the material of the vat 20 may different from that of the casing 80, though this is an option. The vat 20 may have a one piece body of cast metal, of refractory cement, of ceramic, or combinations thereof, as options.

It can be observed that ribs 20A may be defined on the surface of the vat 20, extending vertically as a possibility. The ribs 20A define air channels between them, allow air flow between solid fuel (e.g., wood, charcoal) and the wall of the vat 20. This may contribute to the efficiency of the combustion.

As another option, trays 90 may be provided and accessible from a front face of the casing 80 (or of the ventilation conduit 30 if no casing is present). The tray(s) 90 may alternatively or additionally be used as a drip tray or ash tray, and is essentially configured as a drawer. Moreover, closeable vent holes 91 may be defined in the door of the tray(s) 90. The vent holes 91 (i.e., one or more) are used with a trap 92 that adjusts the size of the air passage. It is possible to adjust the trap 92 to close off completely the vent holes 91. And while the closeable vent holes 91 are shown in the door of the tray(s) 90, they may be elsewhere in the ventilation conduit 30.

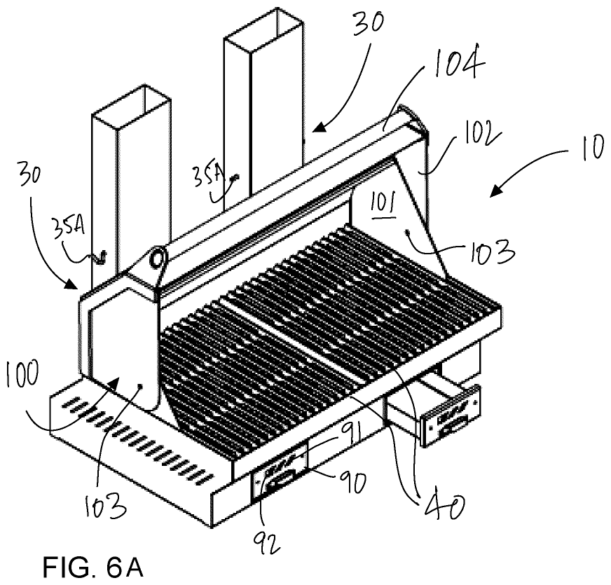

Referring to FIGS. 6A and 6B, a hood 100 may be provided, for any of the cooking apparatuses 10 herein, for instance with the single vat configuration of FIG. 1, or for the double vat configuration as shown in FIGS. 6A and 6B. The hood 100 may have a stationary portion 101 that is mounted to a rear of the cooking apparatus 10, and a movable portion 102, for example as pivoted at 103 (an option among others). Accordingly, the hood 100 may move from a stowed position (FIG. 6A) to a covering position (FIG. 6B). A single hood 100 may cover the entire grill grate 40, but other arrangements are possible, such as one hood per grill grate, etc. In a variant, the hood 100 is fastened to the casing 80 or like structure (e.g., vat 20, ventilation conduit 30) using appropriate devices (screws, bolts, etc). In another variant, the hood 100 may simply be deposited onto the structure of the cooking apparatus 10. A handle 104 may be present to manipulate the movable portion 102.

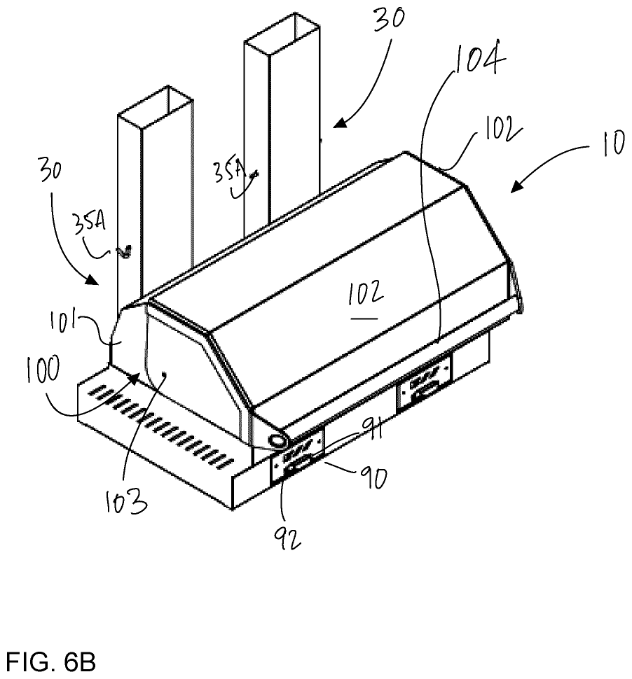

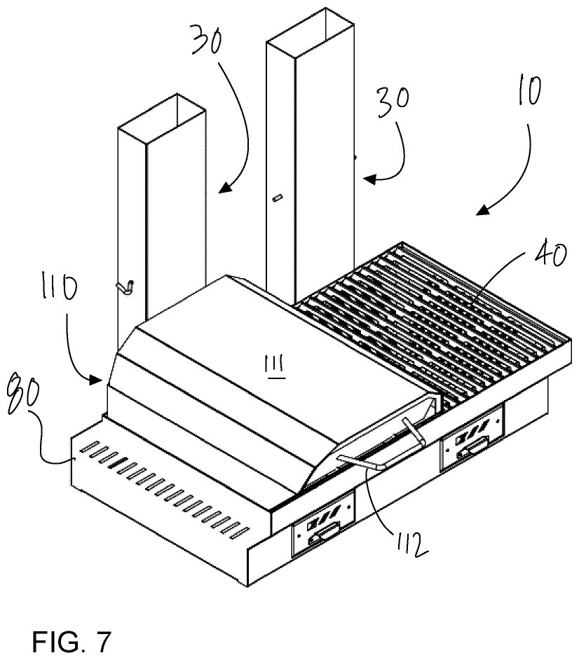

Referring to FIGS. 7 to 10, an oven assembly 110 is illustrated. The oven assembly 110 may be used with the cooking apparatus 10 with a single vat, with a double vat. The oven assembly 110 is shown as being used on a vat 20 of the dual vat cooking apparatus 10, but only for illustrative purposes.

The oven assembly 110 has a casing 111 that has an access door 112. The casing 111 has an open bottom 113, and its bottom peripheral surface 114, surrounding the open bottom 113, is sized so as to be nested in the open end of the vat 20, for example once the grill grate 40 is removed. Accordingly, the heat generated by the open flame is captured in the casing 111, that serves as an oven.

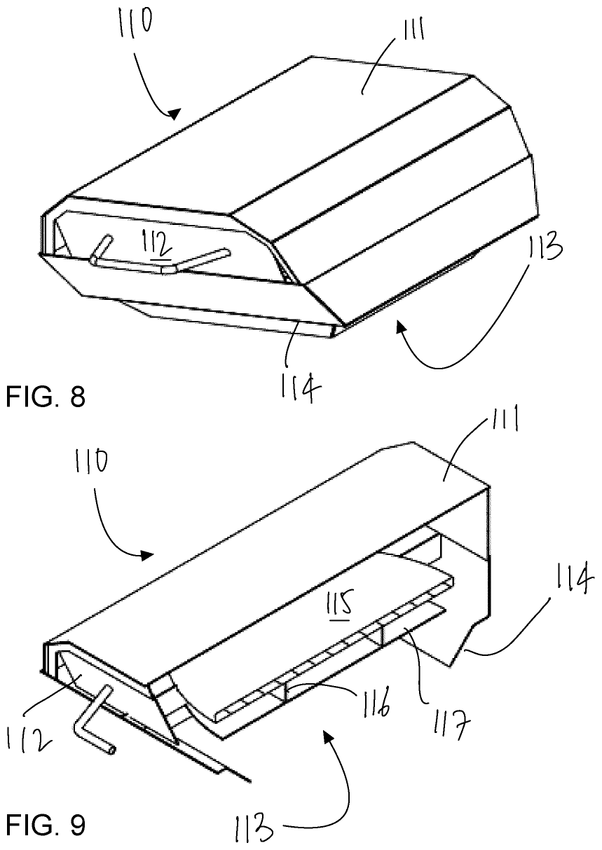

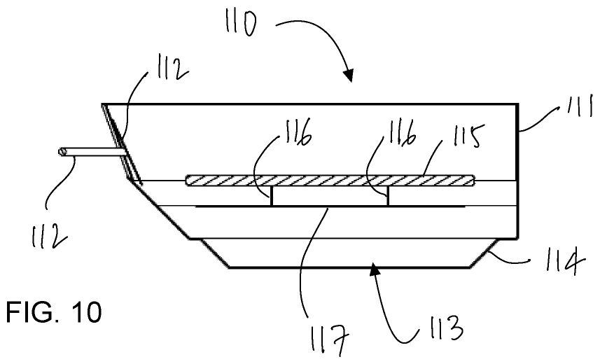

Referring to FIGS. 9 and 10, a plate 115 is optionally supported by beams 116, such that air can freely circulate in the casing 111. The beams 116 may for instance be secured to the side walls of the casing 111. The plate 115 may be made of materials appropriate for cooking pizza or bread, such as stone, refractory cement, ceramic cast iron, among possibilities, to emulate a pizza or bread oven. In a variant, a heat shield 117 may be positioned below the plate 115, for example as spaced apart from it to define an air gap or plenum therebetween. The resulting air gap may contribute to a generally uniform temperature distribution at the plate 115. In an embodiment, the heat shield 117 is connected to an underside of the beams 116 (for example by welding). The plate 115 and heat shield 117 may have the same shape, and may be in register.

1. A cooking apparatus comprising:
a vat configured to accommodate a heat source, the vat having a top open end;
a grate covering the top open end and configured to receive foodstuff thereon to expose the foodstuff to heat from the heat source; and
a ventilation conduit extending from a bottom and/or a side of vat, the ventilation conduit having a first end in fluid communication with the vat, and having a second end away from the vat;
wherein the second end of the ventilation conduit is alternatively an air intake and a smoke exhaust.

2. The cooking apparatus according to claim 1, wherein the vat tapers downwardly, the vat having an inverted truncated square pyramid shape.

3. The cooking apparatus according to claim 1, wherein the vat is made of a refractory cement.

4. The cooking apparatus according to claim 1, wherein the vat has ribs on its inner surface, the ribs defining air channels between the top open end and a bottom of the vat.

5. The cooking apparatus according to claim 1, wherein the vat and the ventilation conduit are in fluid communication via an opening at a bottom of the vat.

6. The cooking apparatus according to claim 1, wherein the second end of the ventilation conduit is an end of a chimney.

7. The cooking apparatus according to claim 6, wherein a trap is provided in the chimney to adjust a size of an air passage of the chimney.

8. The cooking apparatus according to claim 7, wherein the trap is pivotably mounted to a wall of the chimney.

9. The cooking apparatus according to claim 6, wherein a ventilator is connected to the chimney.

10. The cooking apparatus according to claim 6, wherein the chimney has a portion thereof removable from a remainder of the ventilation conduit.

11. The cooking apparatus according to claim 1, wherein closeable vents are provided in the ventilation conduit to enable air passage between the first end and the second end.

12. The cooking apparatus according to claim 1, wherein a removable hood portion is configured to be mounted around the vat.

13. The cooking apparatus according to claim 1, wherein a horizontal plane and a vertical plane pass through the cooking apparatus to form four quadrants, the grate being in a first quadrant, the vat being in a second quadrant, and the ventilation conduit being in the second quadrant, a third quadrant and a fourth quadrant.

14. A method of operating a cooking apparatus comprising:
causing a combustion in a vat of the cooking apparatus;
exposing foodstuff to heat from the combustion on a grate mounted atop the vat; and
inducing an air flow from an environment of the grate, through the vat, and to an exhaust of a ventilation conduit.
